(19) United States
(12) Patent Application Publication
(10) Pub. No.: US 2018/0129603 A1
(43) Pub. Date: May 10, 2018

(54) ELECTRONIC DEVICE AND METHOD FOR ACCESSING MEMORY

(71) Applicant: SAMSUNG ELECTRONICS CO., LTD., Suwon-si (KR)

(72) Inventor: Ik-joon JANG, Suwon-si (KR)

(73) Assignee: SAMSUNG ELECTRONICS CO., LTD., Suwon-si (KR)

(21) Appl. No.: 15/667,190

(22) Filed: Aug. 2, 2017

(30) Foreign Application Priority Data
Nov. 7, 2016 (KR) 10-2016-0147379

(51) Int. Cl. G06F 12/08; G06F 13/28

(52) U.S. Cl. CPC G06F 12/08; G06F 2212/657; G06F 13/28

(57) ABSTRACT

An electronic device including a volatile memory configured to include a plurality of memory rows, the volatile memory including a data bit of a predetermined size and a plurality of tags indicating a plurality of virtual memory addresses corresponding to the plurality of memory rows, and a processor core configured to access the volatile memory using the plurality of virtual memory addresses.

### CROSS-REFERENCE TO RELATED APPLICATIONS

This application claims benefit from Korean Patent Application No. 10-2016-0147379, filed on Nov. 7, 2016 in the Korean Intellectual Property Office, the disclosure of which is incorporated herein by reference in its entirety.

### BACKGROUND OF THE INVENTION

### Field of the Invention

Aspects of the exemplary embodiments relate to an electronic device and a method for accessing a memory, and more particularly, to an electronic device which may access a memory with a virtual memory address without using an address conversion table, and to a method for accessing a memory.

### Description of Related Art

A volatile memory for driving an operating system may be provided on an electronic device. A physical address is used to read and write data on the volatile memory. Generally, a program with larger capacity than a capacity of a main memory cannot be loaded on the memory only with a physical address space, and thus it is impossible to execute the program with a large capacity.

However, a program is executed in a processor in sequence, and thus, only a part of a code of the program which is required by the processor needs to exist in a memory at one point. Accordingly, in order to overcome the above mentioned restriction, a system using a virtual address has been used.

The system using the virtual address requires an operation of converting the virtual address to a physical address in order to access a memory. Generally, the above converting operation is performed by using a conversion table in which the virtual address and the physical address is mapped.

However, the conversion table is stored in a memory. That is, the conversion table occupies a real memory space, and thus a memory overhead occurs. Especially, there is a problem that whenever an address is converted, it is required to access the memory to operate the conversion table.

### SUMMARY OF THE INVENTION

An aspect of the exemplary embodiment has been made to provide an electronic device which may access a memory with a virtual memory address without using an address conversion table, and to a method for accessing a memory.

According to an aspect of an exemplary embodiment, an electronic device includes a volatile memory configured to include a plurality of memory rows, the volatile memory including a data bit of a predetermined size and a plurality of tags indicating a plurality of virtual memory addresses corresponding to the plurality of memory rows, and a processor core configured to access the volatile memory using the plurality of virtual memory addresses.

In response to a virtual memory address being received, the volatile memory may be further configured to retrieve a tag corresponding to the received virtual memory address, and to read a data value of a memory row corresponding to the retrieved tag, or to record a new data value in the memory row.

The volatile memory may be further configured successive virtual memory addresses in a plurality of tags corresponding to successively disposed memory rows so that the successively disposed memory rows correspond to the successive virtual memory addresses.

The processor core may include a function core configured to control at least one function among functions performed by the electronic device, a direct memory access (DMA) configured to access the volatile memory using a virtual memory address requested by the function core, and a memory management device configured to assign the plurality of virtual memory addresses to the plurality of memory rows, and to store the plurality of virtual memory addresses in the plurality of tags.

The memory management device may be further configured to store successive virtual memory addresses in a plurality of tags corresponding to successively disposed memory rows so that the successively disposed memory rows correspond to the successive virtual memory addresses.

The memory management device may be further configured to selectively assign a first virtual memory address corresponding to a number of the plurality of memory rows to each memory row of the plurality of memory rows, or to assign a second virtual memory address which is greater than the number of the memory rows to each memory row of the plurality of memory rows.

The second virtual memory address may include an address to store security data.

The plurality of memory rows may include a dynamic random-access memory (DRAM).

The electronic device may further include a plurality of volatile memories, and the processor core may be further configured to access the plurality of volatile memories.

The electronic device may further include an input-out (I/O) logic configured to access the volatile memory using the plurality of virtual memory addresses.

According to another aspect of an exemplary embodiment, a memory access method includes requesting an access to a volatile memory which includes a plurality of memory rows, the volatile memory including a data bit of a predetermined size and a plurality of tags indicating a plurality of virtual memory addresses corresponding to the plurality of memory rows to a virtual memory address, retrieving a tag from among the plurality of tags, the retrieved tag corresponding to a virtual memory address indicated by the requested access, and accessing a memory row linked to the retrieved tag.

The memory access method may further include reading a data value of the memory row, and outputting the read data value.

The memory access method may further include recording a received data value in the memory row.

The memory access method may further include storing the plurality of virtual memory addresses in the plurality of tags corresponding to the plurality of memory rows.

The memory access method may further include storing successive virtual memory addresses in the plurality of tags corresponding to successively disposed memory rows so that the successively disposed memory rows correspond to the successive virtual memory addresses.

The storing of the plurality of virtual memory addresses may include selectively assigning a first virtual memory address corresponding to a number of the plurality of memory rows to each memory row of the plurality of memory rows, or assigning a second virtual memory address which is more than the number of the memory row to each memory row of the plurality of memory rows.

The second virtual memory address may include an address to store security data.

The requesting may include requesting an access to the volatile memory through direct memory access (DMA).

According to another aspect of an exemplary embodiment, a non-transitory computer readable recording medium includes a program to execute a memory access method, the memory access method including: requesting an access to a volatile memory which includes a plurality of memory rows, the volatile memory including a data bit of a predetermined size and a plurality of tags indicating a plurality of virtual memory addresses corresponding to the plurality of memory rows to a virtual memory address, retrieving a tag from among the plurality of tags, the retrieved tag corresponding to a virtual memory address indicated by the requested access, and accessing a memory row linked to the retrieved tag.

### BRIEF DESCRIPTION OF THE DRAWINGS

FIG. 1 is a block diagram illustrating a configuration of an electronic device according to an exemplary embodiment;

FIG. 2 is a block diagram illustrating a configuration of an electronic device according to an exemplary embodiment;

FIG. 3 is a view provided to explain an operation of a processor core of FIG. 1 according to an exemplary embodiment;

FIG. 4 is a view provided to explain a configuration of a volatile memory according to an exemplary embodiment;

FIG. 5 is a view provided to explain a relation between a tag area and a real address area according to the first exemplary embodiment;

FIG. 6 is a view provided to explain a relation between a tag area and a real address area according to the second exemplary embodiment;

FIG. 7 is a timing diagram provided to explain an operation of reading data of a memory;

FIG. 8 is a timing diagram provided to explain an operation of changing a tag area;

FIG. 9 is a flow chart provided to explain a memory access method according to an exemplary embodiment; and

FIG. 10 is a flow chart provided to explain a method for mapping a dynamic address according to an exemplary embodiment.

### DETAILED DESCRIPTION

Exemplary embodiments may have any number of modifications. Accordingly, specific exemplary embodiments will be illustrated in the drawings and described in detail in the detailed description part. However, this does not necessarily limit the scope of the exemplary embodiments to any specifically described exemplary embodiments. Instead, modifications, equivalents and replacements included in the disclosed concept and technical scope of this specification may be employed. In describing the exemplary embodiments, well-known functions or constructions are not described in detail because they would obscure the specification with unnecessary detail.

The terms such as “first,” “second,” and so on may be used to describe a variety of elements, but the elements should not be limited by these terms. The terms are used to distinguish one component from another component.

The terms used herein are solely intended to explain specific exemplary embodiments, and not to limit the scope of the present disclosure. As used herein, the singular forms are intended to include the plural forms as well, unless the context clearly indicates otherwise. The terms, “include”, “comprise”, “is configured to”, etc. of the description are used to indicate that there are features, numbers, steps, operations, elements, parts or combination thereof, and they should not exclude the possibilities of combination or addition of one or more features, numbers, steps, operations, elements, parts or combination thereof.

In an exemplary embodiment, ‘a module’ or ‘a unit’ performs at least one function or operation, and may be realized as hardware, such as a processor or integrated circuit, software that is executed by a processor, or a combination thereof. In addition, a plurality of ‘modules’ or a plurality of ‘units’ may be integrated into at least one module and may be realized as at least one processor except for ‘modules’ or ‘units’ that should be realized in a specific hardware.

Below, an exemplary embodiment will be described in detail with reference to the attached drawings.

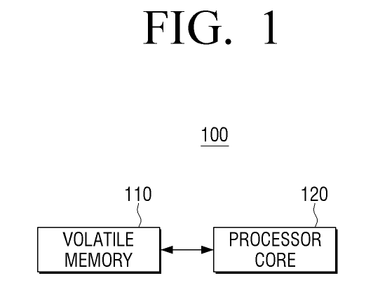

FIG. 1 is a block diagram illustrating a rough configuration of an electronic device according to an exemplary embodiment.

Referring to FIG. 1, an electronic device 100 consists of a volatile memory 110 and a processor core 120.

The volatile memory 110 stores data required to perform the function of the electronic device 100. The volatile memory 110 includes a plurality of memory rows comprised of a data bit of a preset size and a plurality of tags which indicate a virtual memory address for each of the plurality of memory rows.

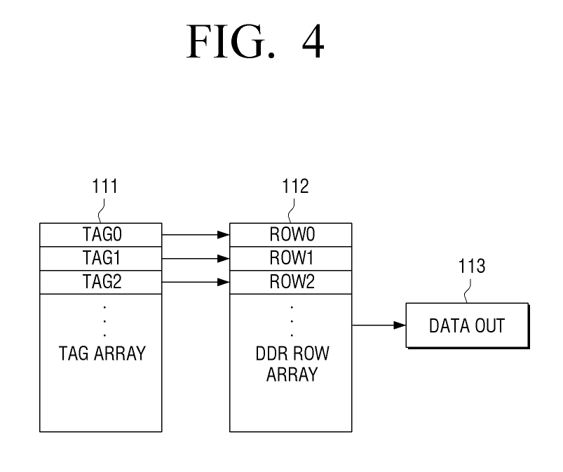

If the virtual memory address is received, the volatile memory 110 retrieves a tag which has the received virtual memory address, and reads a data value of a memory row corresponding to the retrieved tag or records a new data value in the memory row corresponding to the retrieved tag. A specific configuration of the volatile memory 110 will be described below with reference to FIG. 4.

A processor core 120 controls each composition in the electronic device 100. Specifically, the processor core 120 operates by a virtual memory address and accesses the virtual memory address when recording data in the volatile memory 110 or reading data recorded in the volatile memory 110.

The processor core 120 may store a virtual memory address in a plurality of tags in the volatile memory 110. Specifically, the processor core 120 may assign the virtual memory address to each of the plurality of memory rows composing the volatile memory 110. The assigning operation may be performed actively not only in an initial assigning but also in response to a new operation.

The processor core 120 selectively assigns the first virtual memory address corresponding to the number of the memory rows or the second virtual memory address which is greater number than the number of the memory rows, to each of the plurality of memory rows.

For example, the processor core 120 may assign the first virtual memory address to a memory row in which general data will be stored, and assign the second virtual memory address to a memory row in which security data is stored. The processor core 120 may assign the first virtual memory address to a memory row in which the general data is stored, and assign the second virtual memory address to a memory row in which massive data will be stored. The processor core 120 may periodically assign the first virtual memory address until the first viewpoint, and assign the second virtual memory address when assigning a new memory after the first viewpoint.

The processor core 120 stores the virtual memory address assigned to each of the plurality of memory rows in a plurality of tags corresponding to each of the plurality of memory rows.

The processor core 120 stores successive virtual memory addresses in the plurality of tags corresponding to the memory rows which are successively disposed so that some of the successively disposed memory rows among the plurality of memory rows have the successive virtual memory addresses, that is, to compress the memory. The memory compression may be performed in a predetermined periodical unit, and performed when a memory is fragmented over the predetermined fragmentation index.

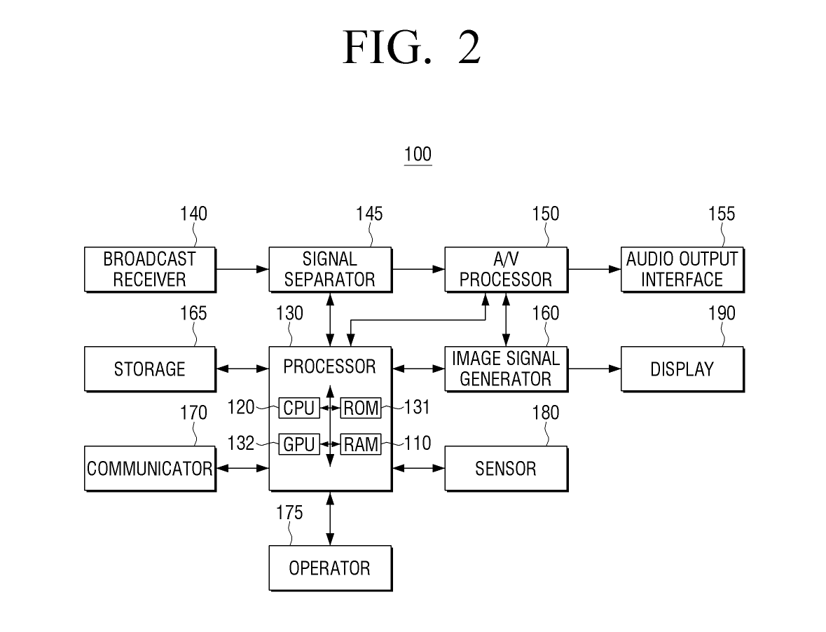

In the above, merely the configuration of the electronic device 100 has been described briefly, but the electronic device 100 may further include a configuration illustrated in FIG. 2. A detailed description of the configuration the electronic device 100 will be provided below with reference to FIG. 2.

FIG. 2 is a block diagram illustrating a specific configuration of the electronic device according to an exemplary embodiment.

Referring to FIG. 2, the electronic device 100 according to this exemplary embodiment may be a display device, and includes a processor 130 (or a controller), a broadcast receiver 140, a signal separator 145, an audio/video (A/V) processor 150, an audio output interface 155, an image signal generator 160, a storage 165, a communicator 170, an operator 175, a sensor 180 and a display 190.

The processor 130 (or a controller) may control an overall operation of the electronic device 100. Specifically, the processor 130 may control each internal configuration of the electronic device 100 so an image according to a control command received through the operator 175 is displayed.

The processor 130 may include a volatile memory 110, a processor core 120, a read only memory (ROM) 131, a Graphic Processing Unit (GPU) 133 and a bus. The volatile memory 110, the processor core 120, the ROM 131, the GPU 133 and so on may be connected to each other though the bus.

The processor core 120 may be a central processing unit (CPU). Because a detailed operation of the processor core 120 has been described in detail with reference to FIG. 1, an overlapped description will be omitted.

In the ROM 131, a command word set for booting a system may be stored. When turn-on instruction is input to supply a power, the processor core 120 copies an operating system (O/S) stored in the storage 165 into the volatile memory 110 according to the command stored in the ROM 131 and executes the O/S to boot the system.

If the booting is completed, the processor core 120 copies various kinds of programs stored in the storage 165 into the volatile memory 110, and performs various kinds of operations by executing the programs copied into the volatile memory 110.

If the booting of the electronic device 100 is completed, the GPU 132 generates a screen including various objects such as an icon, an image, a text, and the like. Specifically, if the electronic device 100 operates in the second operation mode, the GPU 132 generates the screen including a predetermined object on a background image. In addition, the GPU 132 generates the screen including a shadow object which corresponds to the frame of the electronic device 100 and/or the shadow object which corresponds to the displayed object.

The above GPU configuration may be composed of an additional configuration such as an image signal generator 160, and realized as a configuration such as a system on chip (SoC) combined with a CPU in the processor 130.

The GPU 132 may operate by using the memory area of the volatile memory 110. Here, the GPU 132 may access the volatile memory 110 by using a virtual memory address.

Except for the processor core, the device using the volatile memory 110 may be referred to as an input-output (I/O) logic. In addition to the above described GPU, an image processing DSP, a video codec, a microcomputer and the like may be the I/O logic.

The broadcast receiver 140 receives a broadcasting signal in a wired or wireless manner from a broadcasting station or a satellite and demodulate the received broadcasting signal. Specifically, the broadcast receiver 140 receives a transmission stream through an antenna or a cable and demodulate the transmission stream to output a digital transmission stream signal.

The signal separator 145 separates a transmission stream signal provided from the broadcast receiver 140 into an image signal, an audio signal and an additional information signal. The signal separator 145 transmits the image signal and the audio signal to the A/V processor 150.

The A/V processor 150 performs a signal processing, such as a video decoding, a video scaling, and an audio decoding, with respect to the video signal and the audio signal that are input from the broadcast receiver 140 and the storage 165. Also, the A/V processor 150 outputs the image signal to the image signal generator 160 and outputs the audio signal to the audio output interface 155.

In the case of storing the received image and the audio signals in the storage 165, the A/V processor 150 may output the image and the audio to the storage 165 as a compressed form.

The audio output interface 155 converts the audio signal that is output from the A/V processor 150 into a sound, and outputs the sound through a speaker (not illustrated) or through an external output terminal (not illustrated) to an external device connected thereto.

The image signal generator 160 generates a Graphic User Interface (GUI) to provide to a user. Further, the image signal generator 160 may add the generated GUI to an image that is output from the A/V processor 150. The image signal generator 160 provides an image signal corresponding to the image in which the GUI is added to the display 190. Accordingly, the display 190 may display various kinds of information provided by the electronic device 100 or the image transferred from the image signal generator 160.

The image signal generator 160 combines the image output from the A/V processor 150 and the image generated from the GPU 132, and outputs the combined image. In detail, the image signal generator 160 receives a background image in one layer, receives the image generated in the A/V processor 150 in another layer, outputs one of the two layers or synthesizes (or merges) the two layers, and provides the outputted or synthesized (or merged) layer to the display 190.

The image signal generator 160 obtains brightness information corresponding to an image signal, and generates one dimming signal corresponding to the obtained brightness information.

The storage 165 stores an image content. Specifically, the storage 165 may receive and store an image content, in which an image and an audio are compressed, from the A/V processor 150, and may output the stored image content to the A/V processor 150 under the control of the processor 130. The storage 165 may be implemented as a hard disk, a nonvolatile memory, a volatile memory and the like.

The communicator 170 communicates with various types of external devices according to various types of communication methods. The communicator 170 may include a Wifi chip 331 and a Bluetooth chip 332. The processor 130 may communicate with the various types of external devices by using the communicator 170. Specifically, the communicator 170 may receive a control command from a control terminal device (e.g., a remote controller) which can control the electronic device 100.

In addition, although not illustrated in FIG. 2, according to the exemplary embodiments, the communicator 170 may further include a USB port to which a USB connector is connected, various external input ports for connecting various external terminals such as a headset, a mouse, and a LAN, and a DMB chip that receives and processes a Digital Multimedia Broadcasting (DMB) signal.

The operator 175 is realized as a touch screen, a touch pad, a key button, a keypad and the like, and provides a user operation of the electronic device 100. In the exemplary embodiments, an example of receiving a control command through the operator 175 included in the electronic device 100 has been described, but the operator 175 may receive an operation of a user from an external control device (e.g., a remote controller).

The sensor 180 senses surrounding environment of the electronic device. In detail, the sensor 180 senses the brightness condition around the place where a display device is located, or senses whether a user is located in front of the electronic device.

The display 190 displays various types of the information provided by the electronic device 100. Specifically, the display 190 may display a user interface window to select various functions provided by the electronic device 100 or an image provided by the image signal generator 160. The display 190 may be a monitor such as a liquid crystal display (LCD), a Cathode Ray Tube (CRT), an organic light-emitting diode (OLED) and the like, and may be implemented as a touch screen that may simultaneously perform the function of the operator 175 to be described later.

As described above, because a processor core of the electronic device 100 according to exemplary embodiments may access a volatile memory only with a virtual memory address, it is unnecessary for the processor core to convert the virtual memory address to a physical memory address, and thus a conversion table required to convert an address is unnecessary. Accordingly, the electronic device 100 according to the exemplary embodiments does not have to store the conversion table in the volatile memory, and thus there is the effect of expanding a storage space of the volatile memory. Also, because the processor core does not convert an address, the memory access needed to convert an address is not required, and thus a memory overhead may be reduced.

In the description of FIGS. 1 and 2, it has been explained that a memory compressing operation is performed by the processor core 120, but the volatile memory itself may perform the memory compressing operation by additionally including a control logic.

In addition, in the description of FIGS. 1 and 2, it has been explained that the electronic device 100 includes one volatile memory, but when realizing the exemplary embodiment, the electronic device 100 may include a plurality of volatile memories.

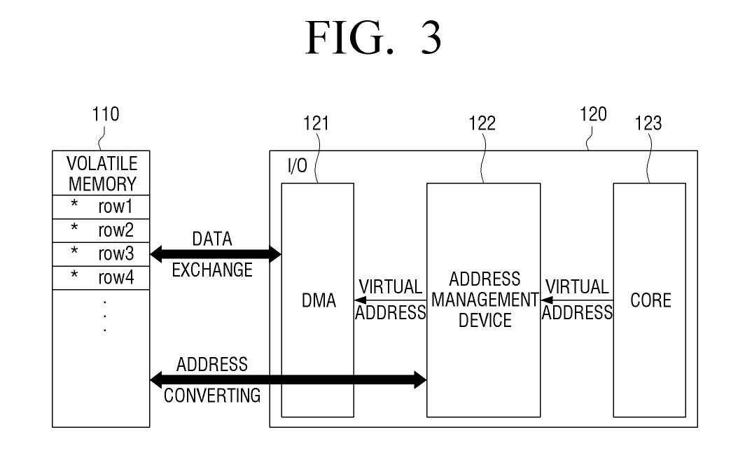

FIG. 3 is a view provided to explain a specific operation of the processor core of FIG. 1 according to an exemplary embodiment.

Referring to FIG. 3, the processor core 120 is composed of a DMA 121, an address management device 122, and a function core 123.

The DMA 121 exchanges data with the volatile memory 110. Specifically, the DMA 121 access the volatile memory 110 by using the virtual memory address required by the function core 123.

The address management device 122 assigns the virtual memory address to each of the plurality of memory rows in the volatile memory 110, and stores the virtual memory address assigned to each of the plurality of memory rows in the plurality of tags corresponding to each of the plurality of memory rows. The assigning operation may be performed actively not only in an initial assigning but also in response to a new operation.

The address management device 122 selectively assigns the first virtual memory address corresponding to the number of the memory rows or the second virtual memory address which is greater number than the number of the memory rows, to each of the plurality of memory rows.

For example, the address management device 122 assigns the first virtual memory address to the memory row in which general data will be stored, and assigns the second virtual memory address to the memory row in which massive data is stored. Alternatively, the address management device 122 assigns the first virtual memory address to the memory row in which the general data is stored, and assigns the second virtual memory address to the memory row in which the massive data will be stored. Alternatively, the address management device 122 periodically assigns the first virtual memory address until the first viewpoint, and assigns the second virtual memory address when assigning a new memory after the first viewpoint.

The address management device 122 stores the virtual memory address assigned to each of the plurality of memory rows in the plurality of tags corresponding to each of the plurality of memory rows.

The address management device 122 stores successive virtual memory addresses in the plurality of tags corresponding to the memory rows which are successively disposed so that some of the successively disposed memory rows among the plurality of memory rows have the successive virtual memory addresses, that is, to compress the memory. The memory compression may be performed in a predetermined periodical unit, and may be performed when the memory is fragmented over the predetermined fragmentation index.

The function core 123 is the processor core which controls at least one special function among the functions provided by the electronic device 100, and processes the data stored in the volatile memory 110. Specifically, the function core 123 according to the exemplary embodiment operates based on the virtual memory address. Accordingly, the function core 123 operates by the virtual memory address, and records data on the volatile memory 110 or accesses the virtual memory address when reading the data recorded in the volatile memory 110.

FIG. 4 is a view provided to explain a configuration of the volatile memory according to an exemplary embodiment.

Referring to FIG. 4, the volatile memory 110 may be composed of a plurality of tags 111, a plurality of memory rows 112, and an output terminal 113.

In the plurality of memory rows 112, the data bit of a predetermined size is disposed in a row unit. This plurality of memory rows 112 may be a dynamic random-access memory (DRAM).

Each of the plurality of tags 111 is linked to the plurality of memory rows, and stores a virtual memory address for each of the memory rows.

The volatile memory 110 according to the exemplary embodiment may be realized as an associative memory (or a contents address memory (CAM)). For example, some bits among each row composing the associative memory are used as the area in which a tag is stored, and the other bits are used as the above mentioned memory rows. Alternatively, the associative memory may be combined with the DRAM.

The output terminal 113 outputs data recorded in the memory rows and may be composed of a buffer.

When describing FIG. 4, it has been described that the volatile memory is realized in one configuration, but generally, the volatile memory can be formed in a bank (or a rank) unit, and thus, the number of the above mentioned volatile memory may be plural. The volatile memory may be composed of various forms, for example, each of the plurality of volatile memories may be composed of a plurality of banks, one bank may be composed of the plurality of volatile memories, and each of the plurality of banks may be composed of the plurality of volatile memories.

The plurality of banks may be accessed separately, and thus the plurality of tags of the plurality of volatile memories comprising one bank may be managed as one unit. For example, if one volatile memory has 1024 rows and one bank is composed of 4 volatile memories, one bank may have 0˜4095 physical address(es).

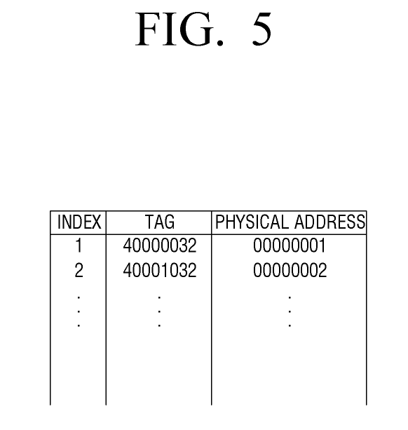

FIG. 5 is a view provided to explain a relation between a tag area and a real address area according to the first exemplary embodiment.

Referring to FIG. 5, in each of the plurality of memory rows, one physical address and one virtual address are mapped. Here, the physical address is a real address of a memory row, and the virtual address is a virtual address assigned to data stored in the corresponding memory row, which is stored in a tag.

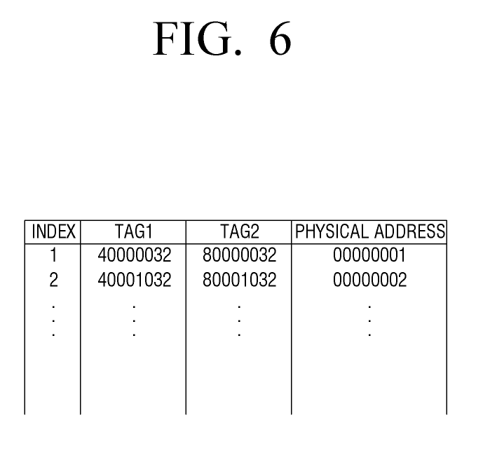

It has been described that only one virtual address is assigned to one memory row, but when realizing an exemplary embodiment, two virtual addresses may be assigned to one memory row. This will be described below with reference to FIG. 6.

FIG. 6 is a view provided to explain the relation between a tag area and a real address area according to the second exemplary embodiment.

In FIG. 6, it is shown that two types of virtual addresses are mapped for one physical address. However, in a tag, only one of two virtual addresses is stored.

As in the above, by using two types of virtual addresses, it may be distinguished whether the data stored in a data row is security data and whether the data stored in a data row was stored after a predetermined time.

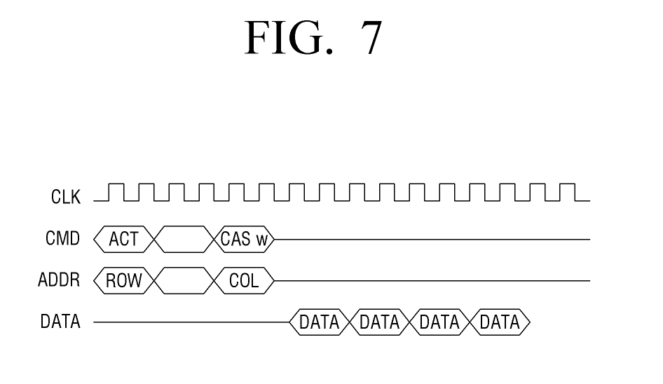

FIG. 7 is a timing diagram provided to explain an operation when data of a memory is read.

Referring to FIG. 7, an ACT (Row activation) is transmitted with a virtual address (ROW), and data is input on a row array after a col address is input in a COLw (Column Write) section. The operation is the same as an existing memory reading method except for using a virtual address, not using a physical address.

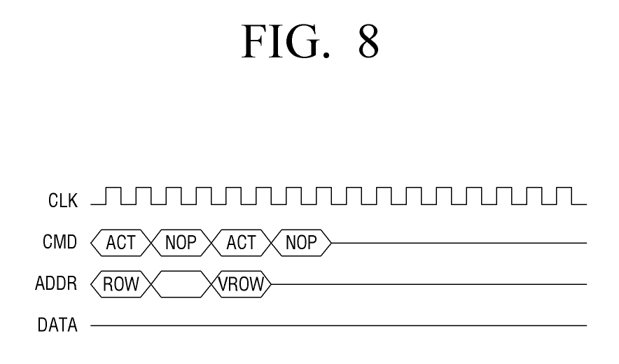

FIG. 8 is a timing diagram provided to explain an operation to change a tag area.

Referring to FIG. 8, the ACT (Row activation) is transmitted with a physical address (ROW), and after then, the ACT (Row activation) and a virtual address are transmitted continuously. Accordingly, the virtual address which is transmitted subsequently is recorded in the tag corresponding to the physical address which is transmitted in advance.

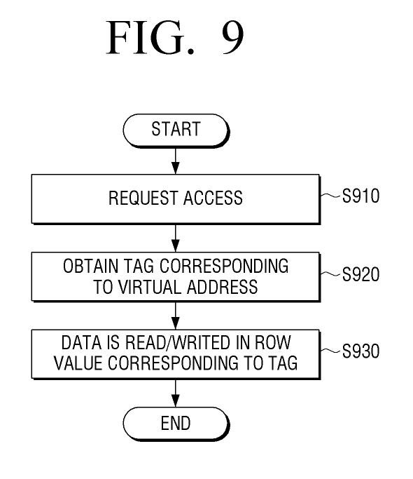

FIG. 9 is a flow chart provided to explain a memory access method according to an exemplary embodiment.

Referring to FIG. 9, first, the virtual memory address is requested through an access to the volatile memory in 5910. Specifically, the access to the volatile memory may be requested from a function I/O in a DMA method, or from a processor core.

Thereafter, a tag corresponding to a requested virtual memory address among a plurality of tags is retrieved in 5920.

An access is performed to a memory row linked to the retrieved tag in 5930. Specifically, a memory row is accessed and a data value is read, and the read data value is output, or the memory row is accessed and a received data value is recorded.

As described above, in the method for accessing a memory according to the exemplary embodiment, because it is possible to access the volatile memory only with the virtual memory address in the processor core, it is unnecessary for the processor core to convert the virtual memory address to a physical memory address, and thus a conversion table required to convert an address is unnecessary. Accordingly, in the memory access method according to the exemplary embodiment, it is unnecessary to store the conversion table in the volatile memory, and thus there is the effect of expanding a storage space of the volatile memory. In addition, in the memory access method according to the exemplary embodiment, because the address converting is not performed in the core, the memory access needed to convert an address is not required, and thus a memory overhead may be reduced. The displaying method of FIG. 9 may be performed in the electronic device having the configuration of FIG. 1 or FIG. 2, and may also be performed in the electronic device having other configurations.

Meanwhile, the method for accessing a memory according to the above-described various exemplary embodiments may be realized as a program and provided in the electronic device. In particular, the program including the method for accessing a memory may be stored in a non-transitory computer readable medium and provided therein.

A non-transitory computer readable medium is a medium that can be read by a computer and that is capable of storing data semi-permanently and not a medium that stores data for a short period of time such as a register, cache and memory and the like. More specifically, the aforementioned various applications or programs may be stored in a non-transitory computer readable medium such as a CD, DVD, hard disc, Blue-ray disc, USB, memory card, or ROM and the like, and be provided.

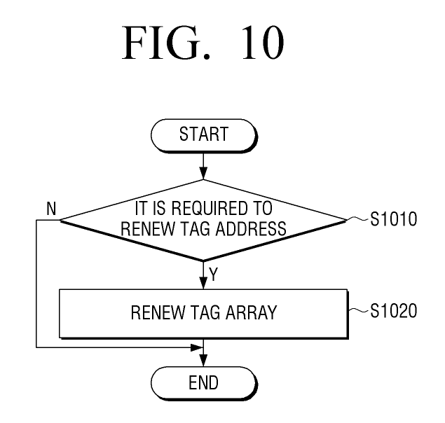

FIG. 10 is a flow chart provided to explain a method for mapping a dynamic address according to an exemplary embodiment.

Referring to FIG. 10, first, a virtual memory address assigned to each of a plurality of memory rows is stored in a plurality of tags corresponding to each of the plurality of memory rows. Here, the first virtual memory address corresponding to the number of the memory rows or the second virtual memory address which is greater than the number of the memory rows are selectively assigned to each of the plurality of memory rows and stored in the plurality of tags.

As in the above, after the virtual memory address is stored in the plurality of tags, it is determined that if a tag address is required to be renewed in S1010. In detail, it is determined that if it is required to compress a memory. This determination is well known art, and thus a detailed description thereof is omitted. However, the determination may be performed in a processor core as well as in a volatile memory.

If it is required to renew the tag address in S1010-Y, successive virtual memory addresses are stored in the plurality of tags corresponding to the memory rows which are successively disposed so that the successively disposed memory rows have the successive virtual memory addresses in S1020.

According to the exemplary embodiment, the operation of mapping the physical address may be performed by changing only the virtual memory address stored in the tag in a volatile memory, and thus there is the effect of reducing an access speed for converting an address. The method for mapping a physical address described in FIG. 10 may be implemented on the electronic device having a configuration of FIG. 1 or FIG. 2, and may also be implemented on the electronic device having other configurations.

The method for mapping a physical address according to the above-described various exemplary embodiments may be realized as a program and provided in an electronic device. In particular, the program including the method for mapping a physical address may be stored in a non-transitory computer readable medium and provided therein.

The foregoing exemplary embodiments and advantages are merely exemplary and are not to be construed as limiting the present invention. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An electronic device comprising:
a volatile memory configured to include a plurality of memory rows, the volatile memory comprising a data bit of a predetermined size and a plurality of tags indicating a plurality of virtual memory addresses corresponding to the plurality of memory rows; and
a processor core configured to access the volatile memory using the plurality of virtual memory addresses.

2. The electronic device as claimed in claim 1, wherein in response to a virtual memory address being received, the volatile memory is further configured to retrieve a tag corresponding to the received virtual memory address, and to read a data value of a memory row corresponding to the retrieved tag, or to record a new data value in the memory row.

3. The electronic device as claimed in claim 1, wherein the volatile memory is further configured to store successive virtual memory addresses in a plurality of tags corresponding to successively disposed memory rows so that the successively disposed memory rows correspond to the successive virtual memory addresses.

4. The electronic device as claimed in claim 1, wherein the processor core comprises:
a function core configured to control at least one function among functions performed by the electronic device;
a direct memory access (DMA) configured to access the volatile memory using a virtual memory address requested by the function core; and
a memory management device configured to assign the plurality of virtual memory addresses to the plurality of memory rows, and to store the plurality of virtual memory addresses in the plurality of tags.

5. The electronic device as claimed in claim 4, wherein the memory management device is further configured to store successive virtual memory addresses in a plurality of tags corresponding to successively disposed memory rows so that the successively disposed memory rows correspond to the successive virtual memory addresses.

6. The electronic device as claimed in claim 4, wherein the memory management device is further configured to selectively assign a first virtual memory address corresponding to a number of the plurality of memory rows to each memory row of the plurality of memory rows, or to assign a second virtual memory address which is greater than the number of the memory rows to each memory row of the plurality of memory rows.

7. The electronic device as claimed in claim 6, wherein the second virtual memory address comprises an address to store security data.

8. The electronic device as claimed in claim 1, wherein the plurality of memory rows comprise a dynamic random-access memory (DRAM).

9. The electronic device as claimed in claim 1, further comprising a plurality of volatile memories,
wherein the processor core is further configured to access the plurality of volatile memories.

10. The electronic device as claimed in claim 1, further comprising:
an input-out (I/O) logic configured to access the volatile memory using the plurality of virtual memory addresses.

11. A memory access method comprising:
requesting an access to a volatile memory which includes a plurality of memory rows, the volatile memory comprising a data bit of a predetermined size and a plurality of tags indicating a plurality of virtual memory addresses corresponding to the plurality of memory rows to a virtual memory address;
retrieving a tag from among the plurality of tags, the retrieved tag corresponding to a virtual memory address indicated by the requested access; and
accessing a memory row linked to the retrieved tag.

12. The memory access method as claimed in claim 11, further comprising:
reading a data value of the memory row, and outputting the read data value.

13. The memory access method as claimed in claim 11, further comprising:
recording a received data value in the memory row.

14. The memory access method as claimed in claim 11, further comprising:
storing the plurality of virtual memory addresses in the plurality of tags corresponding to the plurality of memory rows.

15. The memory access method as claimed in claim 11, further comprising:
storing successive virtual memory addresses in the plurality of tags corresponding to successively disposed memory rows so that the successively disposed memory rows correspond to the successive virtual memory addresses.

16. The memory access method as claimed in claim 14, wherein the storing of the plurality of virtual memory addresses comprises selectively assigning a first virtual memory address corresponding to a number of the plurality of memory rows to each memory row of the plurality of memory rows, or assigning a second virtual memory address which is more than the number of the memory row to each memory row of the plurality of memory rows.

17. The memory access method as claimed in claim 16, wherein the second virtual memory address comprises an address to store security data.

18. The memory access method as claimed in claim 11, wherein the requesting comprises requesting an access to the volatile memory through direct memory access (DMA).

19. A non-transitory computer readable recording medium including a program to execute a memory access method, the memory access method comprising:
requesting an access to a volatile memory which includes a plurality of memory rows, the volatile memory comprising a data bit of a predetermined size and a plurality of tags indicating a plurality of virtual memory addresses corresponding to the plurality of memory rows to a virtual memory address;
retrieving a tag from among the plurality of tags, the retrieved tag corresponding to a virtual memory address indicated by the requested access; and
accessing a memory row linked to the retrieved tag.
